(19) United States
(12) Patent Application Publication
(10) Pub. No.: US 2025/0103126 A1
(43) Pub. Date: Mar. 27, 2025

(54) UTILIZING DATA MODELING FOR POWER MANAGEMENT OF NETWORK DEVICE COMPONENTS

(71) Applicant: Juniper Networks, Inc., Sunnyvale, CA (US)

(72) Inventors: Anthony Joseph LI, Los Altos, CA (US); Jonathan C. BARTH, Collegeville, PA (US); Ronald BONICA, Reston, VA (US); Nicolas FEVRIER, Noyon (FR)

(21) Appl. No.: 18/650,341

(22) Filed: Apr. 30, 2024

(30) Foreign Application Priority Data
Sep. 26, 2023 (IN) 202341064503

(51) Int. Cl. G06F 1/3234; G06F 1/3206

(52) U.S. Cl. CPC G06F 1/3234; G06F 1/3206

(57) ABSTRACT

A device may utilize a data modeling language to generate a request to identify components of a network device and operational dependencies of the components, and may provide the request to the network device. The device may receive, based on the request, data identifying the components and the operational dependencies of the components, and may receive power consumptions by the components and power off capabilities of the components. The device may generate a model of power consumptions by the components based on the power consumptions by the components and the power off capabilities of the components, and may identify, from the components, a component capable of powering off based on the model. The device may instruct the network device to place the component in a power save state.

### CROSS-REFERENCE TO RELATED APPLICATION

This Patent application claims priority to India Provisional Patent Application No. 202341064503, filed on Sep. 26, 2023, entitled “SYSTEMS AND METHODS FOR PROVIDING ENERGY EFFICIENT NETWORKS,” and assigned to the assignee hereof. The disclosure of the prior Application is considered part of and is incorporated by reference into this Patent Application.

### BACKGROUND

Networks consume significant amounts of power at a time when a cost of power is rising and sensitivity about sustainability is very high. Thus, network operators continuously attempt to optimize the power efficiency of networks at a micro level and at a macro level.

### SUMMARY

Some implementations described herein relate to a method. The method may include utilizing a data modeling language to generate a request to identify components of a network device and operational dependencies of the components, and providing the request to the network device. The method may include receiving, based on the request, data identifying the components and the operational dependencies of the components, and receiving power consumptions by the components and power off capabilities of the components. The method may include generating a model of power consumptions by the components based on the power consumptions by the components and the power off capabilities of the components, and identifying, from the components, a component capable of powering off based on the model. The method may include instructing the network device to place the component in a power save state.

Some implementations described herein relate to a device. The device may include one or more memories and one or more processors. The one or more processors may be configured to utilize a data modeling language to generate a request to identify components of a network device and operational dependencies of the components, and provide the request to the network device. The one or more processors may be configured to receive, based on the request, data identifying the components and the operational dependencies of the components, and receive power consumptions by the components and power off capabilities of the components. The one or more processors may be configured to generate a model of power consumptions by the components based on the power consumptions by the components and the power off capabilities of the components, and identify, from the components, a component capable of powering off based on the model. The one or more processors may be configured to instruct the network device to place the component in a power save state, and receive, a traffic load associated with the network device. The one or more processors may be configured to instruct the network device to remove the power save state for the component based on the traffic load.

Some implementations described herein relate to a non-transitory computer-readable medium that stores a set of instructions. The set of instructions, when executed by one or more processors of a device, may cause the device to utilize a data modeling language to generate a request to identify components of a network device and operational dependencies of the components, and provide the request to the network device. The set of instructions, when executed by one or more processors of the device, may cause the device to receive, based on the request, data identifying the components and the operational dependencies of the components, and receive power consumptions by the components and power off capabilities of the components, wherein the power off capabilities of the components indicate that the components are capable of being powered off or are incapable of being powered off. The set of instructions, when executed by one or more processors of the device, may cause the device to generate a model of power consumptions by the components based on the power consumptions by the components and the power off capabilities of the components, and identify, from the components, a component capable of powering off based on the model. The set of instructions, when executed by one or more processors of the device, may cause the device to instruct the network device to place the component in a power save state.

### BRIEF DESCRIPTION OF THE DRAWINGS

FIGS. 1A-1E are diagrams of an example associated with utilizing data modeling for power management of network device components.

FIG. 2 is a diagram of an example environment in which systems and/or methods described herein may be implemented.

FIGS. 3 and 4 are diagrams of example components of one or more devices of FIG. 2.

FIG. 5 is a flowchart of an example process for utilizing data modeling for power management of network device components.

### DETAILED DESCRIPTION

The following detailed description of example implementations refers to the accompanying drawings. The same reference numbers in different drawings may identify the same or similar elements.

Traffic levels through a network fluctuate and when traffic decreases (e.g., during non-peak times) there is much more network capacity than is needed. All active components of network devices that are powered on may cost network operators power and money, regardless of whether the components are actually performing useful work. Powering off one or more components of network devices could save a significant amount of power. However, currently there is no scaled and practical mechanism to power off network device components, and there is no mechanism capable of indicating and/or controlling power consumptions by the network device components. Thus, current techniques for managing networks consume computing resources (e.g., processing resources, memory resources, communication resources, and/or the like), networking resources, and/or the like are associated with failing to determine power consumptions by network device components, failing to power off unused components of network devices during non-peak utilization times, unnecessarily maintaining the unused components of the network devices during non-peak utilization times of the network, and/or the like.

Some implementations described herein relate to a device (e.g., a management system) that utilizes data modeling for power management of network device components. For example, the device may utilize a data modeling language to generate a request to identify components of a network device and operational dependencies of the components, and may provide the request to the network device. The device may receive, based on the request, data identifying the components and the operational dependencies of the components, and may receive power consumptions by the components and power off capabilities of the components. The device may generate a model of power consumptions by the components based on the power consumptions by the components and the power off capabilities of the components, and may identify, from the components, a component capable of powering off based on the model. The device may instruct the network device to place the component in a power save state.

In this way, the device utilizes data modeling for power management of network device components. For example, the device may provide a standardized mechanism for network operators to understand, monitor, and control power consumption by components of network devices. The device may utilize a model (e.g., a yet another next generation (YANG) model) to monitor and control the power consumption by the components of the network devices. Based on the monitored power consumption, the device may place one or more components of a network device into a power save state that powers off the one or more components when unused and powers on the one or more components when required. Thus, the device conserves computing resources, networking resources, and/or the like that would otherwise have been consumed by failing to determine power consumptions by network device components, failing to power off unused components of network devices during non-peak utilization times, unnecessarily maintaining the unused components of the network devices during non-peak utilization times of the network, and/or the like.

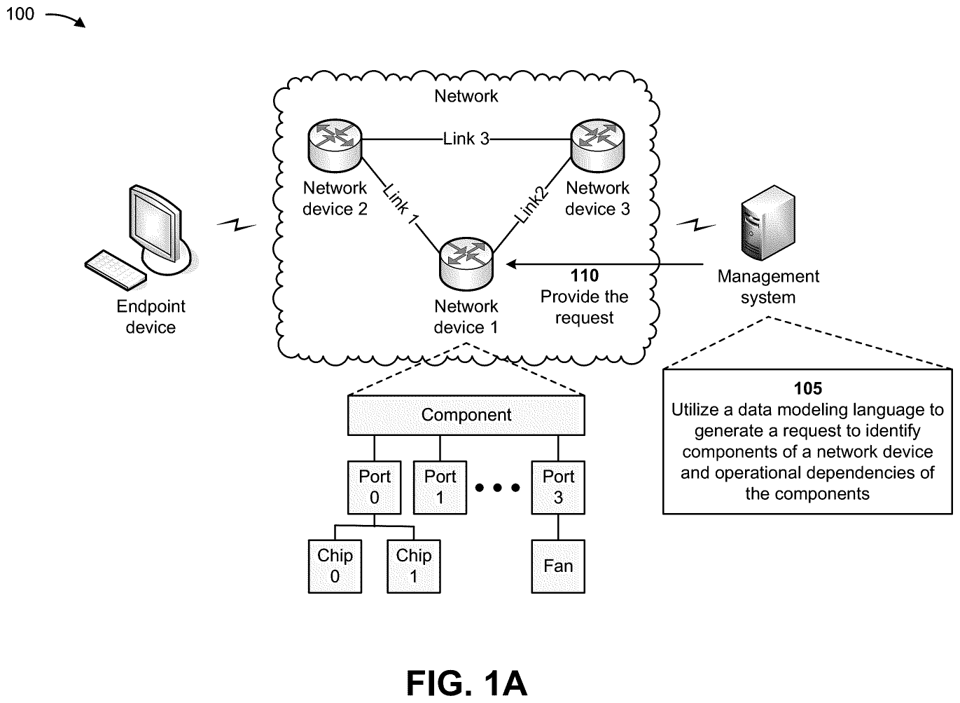

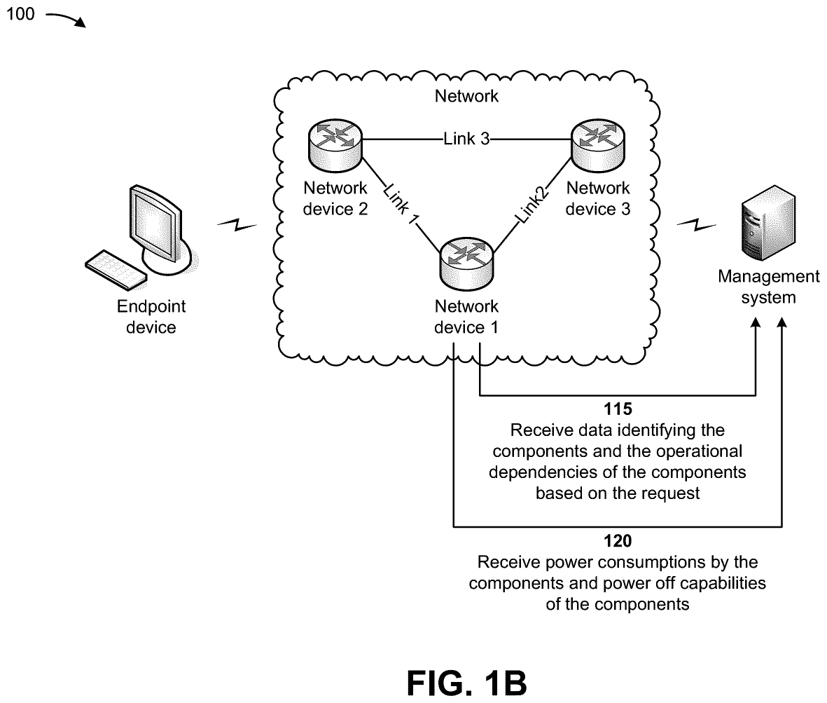

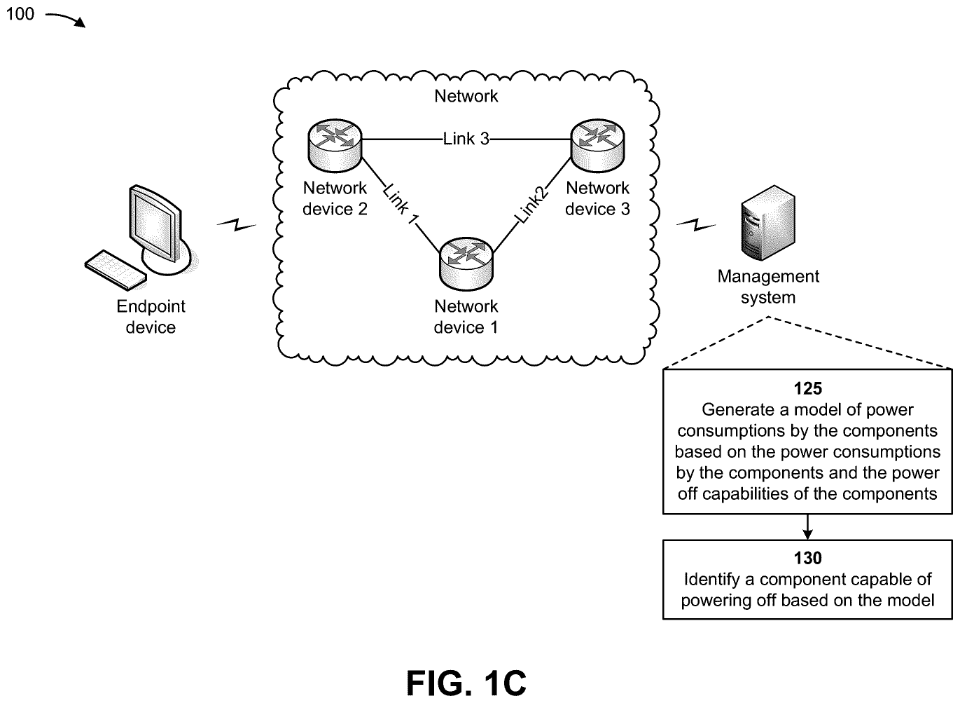

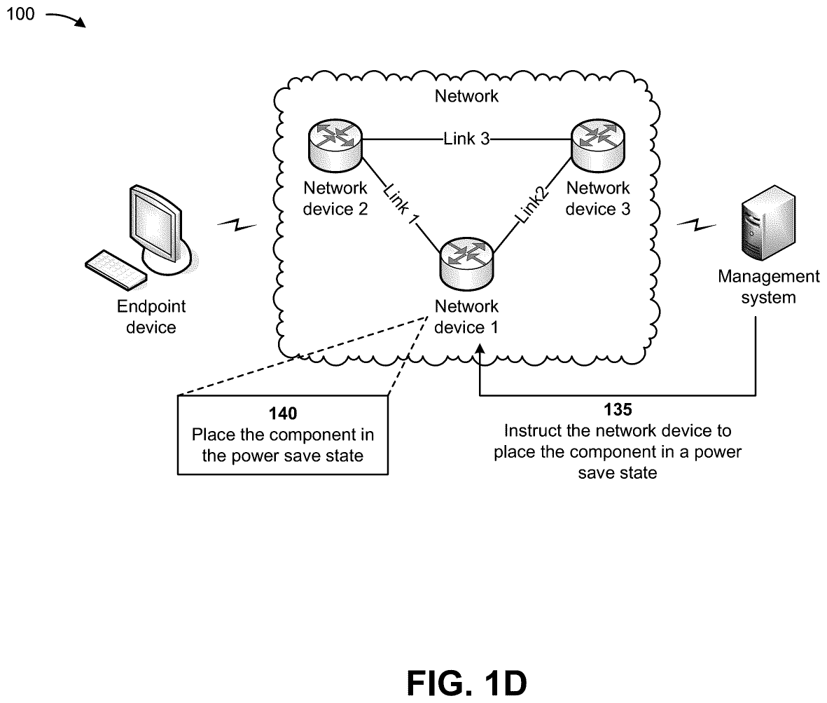

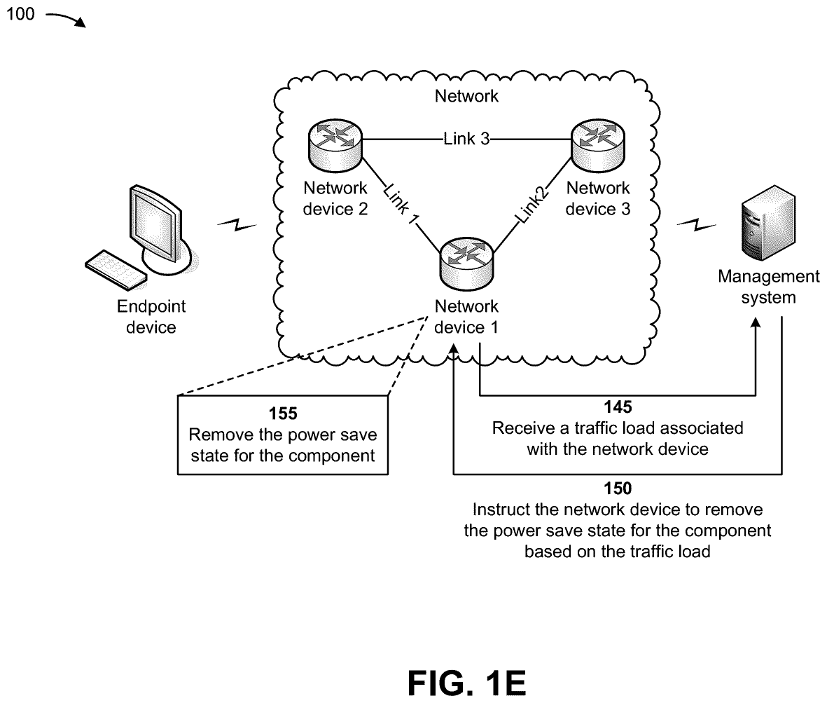

FIGS. 1A-1E are diagrams of an example 100 associated with utilizing data modeling for power management of network device components. As shown in FIGS. 1A-1E, the example 100 includes an endpoint device associated with a network and a management system. The network may include multiple network devices, such as a first network device (e.g., network device 1), a second network device (e.g., network device 2), and a third network device (e.g., network device 3). A first link (e.g., link 1) may be provided between the first network device and the second network device, a second link (e.g., link 2) may be provided between the first network device and the third network device, and a third link (e.g., link 3) may be provided between the second network device and the third network device. Further details of the endpoint device, the management system, the network, the network devices, and the links are provided elsewhere herein.

As shown in FIG. 1A, and by reference number 105, the management system may utilize a data modeling language to generate a request to identify components of a network device and operational dependencies of the components. For example, the management system may provide a standardized mechanism for a network operator to understand, monitor, and control power consumption of a network device. The management system may utilize a data modeling language, such as a YANG data modeling language for system management, to generate the request to identify components of the network device and the operational dependencies of the components. In some implementation, the management system may utilize the YANG data modeling language in conjunction with a protocol, such as a network configuration protocol (NETCONF).

The current YANG model provides some mechanisms for system management, but do not include details about power consumption and power control. The management system may extend and enhance the current YANG model to provide details about power consumption and power control. The YANG model for hardware management is an Internet Engineering Task Force (IETF) model intended for server device hardware, but may be extended to hardware for network devices. Actual implementations of the YANG model are frequently open configuration (OpenConfig) models, rather than IETF models. The management system may extend the IETF models and the OpenConfig models to provide details about power consumption and power control.

The current YANG model for hardware management provides for a hierarchical model of components of a device. However, this hierarchy strictly describes physical relationships (e.g., via “contains child” and “parent” relationships) among components and does not describe functional dependencies of the components. The management system may enhance the current YANG model to include operational dependencies of the components of the network device for more complete modeling. The operational dependencies of the components may include a “requires” dependency, a “used by” dependency, and/or the like. For example, the YANG model may include an operational dependency indicating a set of switch cards of the network device that is required by a line card of the network device, and that a line card of the network device is used by a switch card of the network device. The management system may extend this hierarchy in further detail (e.g., down to a chip level) so that the network device may provide relationships between chips.

As further shown in FIG. 1A, and by reference number 110, the management system may provide the request to the network device. For example, after generating the request to identify the components of the network device and the operational dependencies of the components, the management system may provide the request to the network device. The network device may receive the request, and may perform the functions requested by the request.

As shown in FIG. 1B, and by reference number 115, the management system may receive data identifying the components and the operational dependencies of the components based on the request. For example, the network device may identify the components of the network device and the operational dependencies of the components based on the request, and may generate the data identifying the components and the operational dependencies of the components based on the request. The network device may provide the data identifying the components and the operational dependencies of the components to the management system, and the management system may receive the data identifying the components and the operational dependencies of the components from the network device. In some implementations, the management system may receive data identifying components of all the network devices of the network and operational dependencies of such components.

As further shown in FIG. 1B, and by reference number 120, the management system may receive power consumptions by the components and power off capabilities of the components. For example, the network device may continuously determine the power consumptions by the components, may periodically determine the power consumptions by the components, may determine the power consumptions by the components based on the request, and/or the like. The network device may provide the power consumptions by the components to the management system, and the management system may receive the power consumptions by the components from the network device. The power consumptions may enable the management system to model the power consumptions by the components (e.g., power utilization of fans, switch cards, interface cards, individual chips, and/or the like). In some implementations, the power consumptions by the components may not be real-time power consumptions, but may be static approximations of the power consumptions by the components. In some implementations, a power consumption by a component may not include power consumptions of any child components that have explicit power consumption modeling.

The management system may place one or more of the components into an operational state referred to as a “power save state.” When a component is configured in the power save state, the component may be powered off but not prohibited from operation, and may be powered on as needed. In some implementations, not all components of the network device may support the power save state. Thus, the network device may generate indications of power off capabilities of the components (e.g., whether the components may utilize the power save state), and may provide the indications of the power off capabilities of the components to the management system. The management system may receive the indications of the power off capabilities of the components from the network device. In some implementations, the management system may automatically place a particular component in the hierarchy in the power save state if components dependent on the particular component are in the power save state (e.g., even when the particular component is not explicitly placed in the power save state).

As shown in FIG. 1C, and by reference number 125, the management system may generate a model of power consumptions by the components based on the power consumptions by the components and the power off capabilities of the components. For example, based on the power consumptions by the components and the power off capabilities of the components, the management system may generate a model (e.g., a YANG model for hardware management) that provides a hierarchical model of the components of the network device. The hierarchy strictly may describe physical relationships (e.g., via “contains child” and “parent” relationships) among the components as well as functional dependencies of the components. The management system may include the operational dependencies of the components (e.g., the power consumptions by the components and the power off capabilities of the components) of the network device in the generated model. The operational dependencies of the components may include a “requires” dependency, a “used by” dependency, and/or the like. For example, the model may include an operational dependency indicating a set of ports of the network device is required by a processing component of the network device, and that a processing component of the network device is used by a switch card of the network device. The management system may extend the hierarchy in further detail (e.g., down to a chip level) so that the network device may provide relationships between chips.

In one example, the management system may generate the following partial tree diagram as the model of power consumptions by the components:

hardware

+−−rw component
+−−rw chassis-attributes
+−−ro name? string /EDGE-1
+−−ro loopbackAddres inet:ip-address /192.0.2.1
+−−ro class string /chassis
+−−ro mfg-name string /NAME
+−−ro mfg-model string /MODEL
+−−ro mfg-hw-ver string /2.4
+−−ro currentPwrdraw uint32 /300
+−−ro contains-child
+−−ro string /EDGE-1/ps0
+−−ro string /EDGE-1/ps1
+−−ro string /EDGE-1/RE0
+−−ro string /EDGE-1/RE1
+−−ro string /EDGE-1/fan0
+−−ro string /EDGE-1/fan1
+−−ro string /EDGE-1/sib0
+−−ro string /EDGE-1/sib1
+−−ro string /EDGE-1/lc0
+−−ro string /EDGE-1/lc1
+−−ro AdminStatus ennumeration /Up
+−−ro OpStatus ennumeration /Up
+−−rw power-save-capable boolean /False
+−−rw power-save boolean /False
+−−rw[power supply attributes]
+−−ro name? string /EDGE-1/ps0
+−−ro class string /power supply
+−−ro mfg-name string /NAME
+−−ro mfg-model string /MODEL
+−−ro mfg-hw-ver string /2.2
+−−ro currentPwrdraw uint32 /30
+−−ro AdminStatus ennumeration /Up
+−−ro OpStatus ennumeration /Up
+−−ro parent string EDGE-1
+−−rw power-save-capable boolean /False
+−−rw power-save boolean /False
+−−rw [re attributes]
+−−ro name? string /EDGE-1/RE0
+−−ro class string /module
+−−ro mfg-name string /NAME
+−−ro mfg-model string /MODEL
+−−ro mfg-hw-ver string /2.2
+−−ro currentPwrdraw uint32 /300
+−−ro AdminStatus ennumeration /Up
+−−ro OpStatus ennumeration /Up
+−−ro parent string EDGE-1
+−−rw power-save-capable boolean /False
+−−rw power-save boolean /False
+−−ro used-by:
+−−ro name: EDGE-1/lc0
+−−ro name: EDGE-1/lc1
+−−rw[fan attributes]
+−−ro name? string /EDGE-1/FAN
+−−ro class string /fan
+−−ro mfg-name string /NAME
+−−ro mfg-model string /MODEL
+−−ro mfg-hw-ver string /2.2
+−−ro currentPwrdraw uint32 /30
+−−ro AdminStatus ennumeration /Up
+−−ro OpStatus ennumeration /Up
+−−ro parent string EDGE-1
+−−rw power-save-capable boolean /False
+−−rw power-save boolean /False
+−−rw[sib-attributes]
+−−ro name? string /EDGE-1/SIB0
+−−ro class string /backplane
+−−ro mfg-name string /NAME
+−−ro mfg-model string /MODEL
+−−ro mfg-hw-ver string /2.2
+−−ro currentPwrdraw uint32 /30
+−−ro AdminStatus ennumeration /Up
+−−ro OpStatus ennumeration /Up
+−−ro parent string /EDGE-1
+−−rw power-save-capable boolean /True
+−−rw power-save boolean /False
+−−ro used-by:
+−−ro name: EDGE-1/lc0
+−−rw[lineCardAttributes]
+−−ro name? string /EDGE-1/lco
+−−ro class string /module
+−−ro mfg-name string /NAME
+−−ro mfg-model string /MODEL
+−−ro mfg-hw-ver string /2.2
+−−ro currentPwrdraw uint32 /30
+−−ro AdminStatus ennumeration /Up
+−−ro OpStatus ennumeration /Up
+−−ro parent string /EDGE-1
+−−rw power-save-capable boolean /True
+−−rw power-save boolean /False
+−−ro contains-child
+−−ro string /EDGE-1/lc0/pfe0
+−−ro string /EDGE-1/lc1/pfe0
+−− requires:
+−−ro EDGE-1/SIB0
+−−rw[pfe attributes]
+−−ro name? string /EDGE-1/lco/pfe0
+−−ro class string /cpu
+−−ro mfg-name string /NAME
+−−ro mfg-model string /MODEL
+−−ro mfg-hw-ver string /2.2
+−−ro currentPwrdraw uint32 /30
+−−ro AdminStatus ennumeration /Up
+−−ro OpStatus ennumeration /Up
+−−ro parent string /EDGE-1/lc0
+−−rw power-save-capable boolean /False
+−−rw power-save boolean /False
+−−rw [pic attributes]
+−−ro name? string /EDGE-1/lco/pic0
+−−ro class string /module
+−−ro mfg-name string /NAME
+−−ro mfg-model string /MODEL
+−−ro mfg-hw-ver string /2.2
+−−ro currentPwrdraw uint32 /30
+−−ro AdminStatus ennumeration /Up
+−−ro OpStatus ennumeration /Up
+−−ro parent string /EDGE-1/lc0
+−−rw power-save-capable boolean /False
+−−rw power-save boolean /False
+−−ro contains-child
+−−ro string /EDGE-1/lc0/pic0/port0
+−−ro string /EDGE-1/lc1/pic0/port1
+−−ro EDGE-1/lc0/pfe0
+−−rw [port attributes]
+−−ro name? string /EDGE-1/lco/pic0/port0
+−−ro class string /port
+−−ro mfg-name string /NAME
+−−ro mfg-model string /MODEL
+−−ro mfg-hw-ver string /2.2
+−−ro currentPwrdraw uint32 /30
+−−ro AdminStatus ennumeration /Up
+−−ro OpStatus ennumeration /Up
+−−ro parent string /EDGE-1/lc0/pic0
+−−rw power-save-capable boolean /False
+−−rw power-save boolean /False.

As further shown in FIG. 1C, and by reference number 130, the management system may identify a component capable of powering off based on the model. For example, the management system may determine that a component of the network device may be powered off to conserve energy consumed by the network device. The management system may analyze the model of power consumptions by the components (e.g., to identify an unused component that is capable of powering off), and may identify the component based on analyzing the model of power consumptions by the components.

As shown in FIG. 1D, and by reference number 135, the management system may instruct the network device to place the component in a power save state. For example, after identifying the component capable of powering off, the management system may generate a command that instructs the network device to place the component in the power save state. The management system may provide the command to the network device, and the network device may be instructed to place the component in the power save state based on the command.

As further shown in FIG. 1D, and by reference number 140, the network device may place the component in the power save state. For example, the network device may receive the command that instructs the network device to place the component in the power save state, and the network device may place the component in the power save state based on the command. When the component is placed in the power save state, the component is powered off, is not prohibited from functioning, and may be powered on as needed (e.g., due to increased traffic load at the network device).

As shown in FIG. 1E, and by reference number 145, the management system may receive a traffic load associated with the network device. For example, the network device may receive a traffic load (e.g., based on traffic received from the endpoint device), and may report the traffic load to the management system. The management system may receive the traffic load from the network device.

As further shown in FIG. 1E, and by reference number 150, the management system may instruct the network device to remove the power save state for the component based on the traffic load. For example, the management system may determine that the component in the power save state is now required to process the traffic load associated with the network device (e.g., when the traffic load increases from a previous traffic load experienced by the network device). The management system may generate a command that instructs the network device to remove the power save state for the component based on determining that the component in the power save state is now required to process the traffic load. The management system may provide the command to the network device, and the network device may be instructed to remove the power save state for the component based on the command.

As further shown in FIG. 1E, and by reference number 155, the network device may remove the power save state for the component. For example, the network device may receive the command that instructs the network device to remove the power save state for the component, and the network device may remove the power save state for the component based on the command. When the component is removed from the power save state, the component is powered on and may process the traffic load for the network device.

In this way, the device utilizes data modeling for power management of network device components. For example, the device may provide a standardized mechanism for network operators to understand, monitor, and control power consumption by components of network devices. The device may utilize a model (e.g., a YANG model) to monitor and control the power consumption by the components of the network devices. Based on the monitored power consumption, the device may place one or more components of a network device into a power save state that powers off the one or more components when unused and powers on the one or more components when required. Thus, the device conserves computing resources, networking resources, and/or the like that would otherwise have been consumed by failing to determine power consumptions by network device components, failing to power off unused components of network devices during non-peak utilization times, unnecessarily maintaining the unused components of the network devices during non-peak utilization times of the network, and/or the like.

As indicated above, FIGS. 1A-1E are provided as an example. Other examples may differ from what is described with regard to FIGS. 1A-1E. The number and arrangement of devices shown in FIGS. 1A-1E are provided as an example. In practice, there may be additional devices, fewer devices, different devices, or differently arranged devices than those shown in FIGS. 1A-1E. Furthermore, two or more devices shown in FIGS. 1A-1E may be implemented within a single device, or a single device shown in FIGS. 1A-1E may be implemented as multiple, distributed devices. Additionally, or alternatively, a set of devices (e.g., one or more devices) shown in FIGS. 1A-1E may perform one or more functions described as being performed by another set of devices shown in FIGS. 1A-1E.

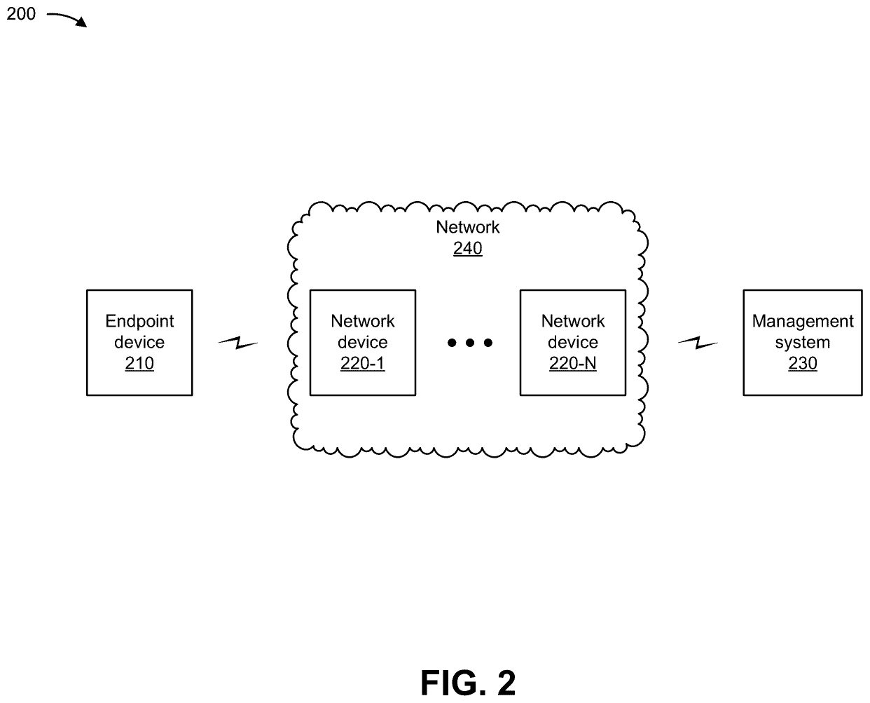

FIG. 2 is a diagram of an example environment 200 in which systems and/or methods described herein may be implemented. As shown in FIG. 2, environment 200 may include an endpoint device 210, a group of network devices 220 (shown as network device 220-1 through network device 220-N), a management system 230, and a network 240. Devices of the environment 200 may interconnect via wired connections, wireless connections, or a combination of wired and wireless connections.

The endpoint device 210 includes one or more devices capable of receiving, generating, storing, processing, and/or providing information, such as information described herein. For example, the endpoint device 210 may include a mobile phone (e.g., a smart phone or a radiotelephone), a laptop computer, a tablet computer, a desktop computer, a handheld computer, a gaming device, a wearable communication device (e.g., a smart watch, a pair of smart glasses, a heart rate monitor, a fitness tracker, smart clothing, smart jewelry, or a head mounted display), a network device, a server device, a group of server devices, or a similar type of device. In some implementations, the endpoint device 210 may receive network traffic from and/or may provide network traffic to other endpoint devices 210 and/or the management system 230, via the network 240 (e.g., by routing packets using the network devices 220 as intermediaries).

The network device 220 includes one or more devices capable of receiving, processing, storing, routing, and/or providing traffic (e.g., a packet or other information or metadata) in a manner described herein. For example, the network device 220 may include a router, such as a label switching router (LSR), a label edge router (LER), an ingress router, an egress router, a provider router (e.g., a provider edge router or a provider core router), a virtual router, a route reflector, an area border router, or another type of router. Additionally, or alternatively, the network device 220 may include a gateway, a switch, a firewall, a hub, a bridge, a reverse proxy, a server (e.g., a proxy server, a cloud server, or a data center server), a load balancer, and/or a similar device. In some implementations, the network device 220 may be a physical device implemented within a housing, such as a chassis. In some implementations, the network device 220 may be a virtual device implemented by one or more computer devices of a cloud computing environment or a data center. In some implementations, a group of network devices 220 may be a group of data center nodes that are used to route traffic flow through the network 240.

The management system 230 may include one or more devices capable of receiving, generating, storing, processing, providing, and/or routing information, as described elsewhere herein. The management system 230 may include a communication device and/or a computing device. For example, the management system 230 may include a server, such as an application server, a client server, a web server, a database server, a host server, a proxy server, a virtual server (e.g., executing on computing hardware), or a server in a cloud computing system. In some implementations, the management system 230 may include computing hardware used in a cloud computing environment.

The network 240 includes one or more wired and/or wireless networks. For example, the network 240 may include a packet switched network, a cellular network (e.g., a fifth generation (5G) network, a fourth generation (4G) network, such as a long-term evolution (LTE) network, a third generation (3G) network, a code division multiple access (CDMA) network, a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

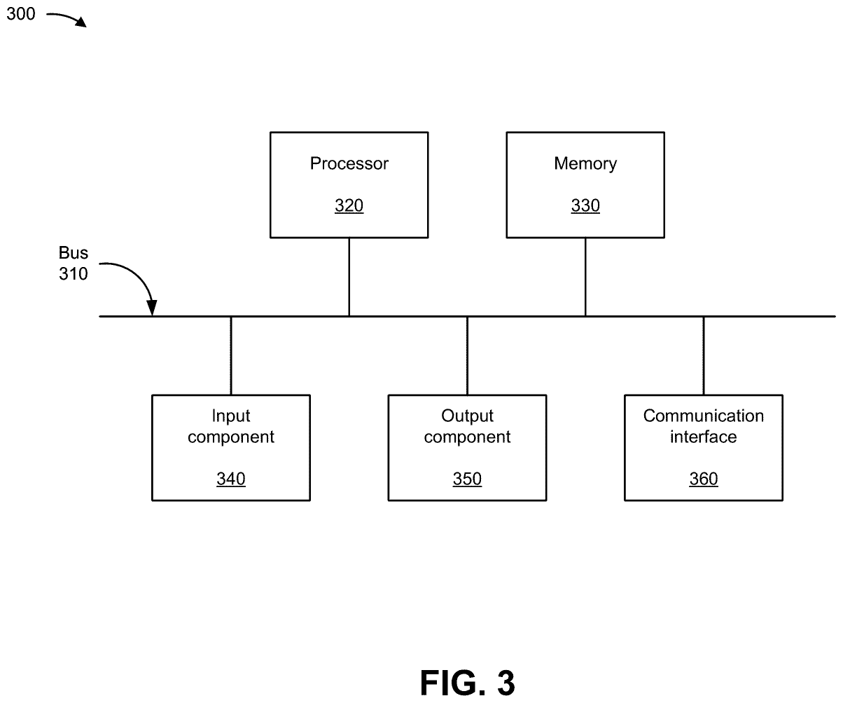

FIG. 3 is a diagram of example components of one or more devices of FIG. 2. The example components may be included in a device 300, which may correspond to the endpoint device 210, the network device 220, and/or the management system 230. In some implementations, the endpoint device 210, the network device 220, and/or the management system 230 may include one or more devices 300 and/or one or more components of the device 300. As shown in FIG. 3, the device 300 may include a bus 310, a processor 320, a memory 330, an input component 340, an output component 350, and a communication interface 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit (CPU), a graphics processing unit (GPU), an accelerated processing unit (APU), a microprocessor, a controller, a microcontroller, a digital signal processor (DSP), a field-programmable gate array (FPGA), an application-specific integrated circuit (ASIC), and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication interface 360 enables the device 300 to communicate with other devices via a wired connection and/or a wireless connection. For example, the communication interface 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

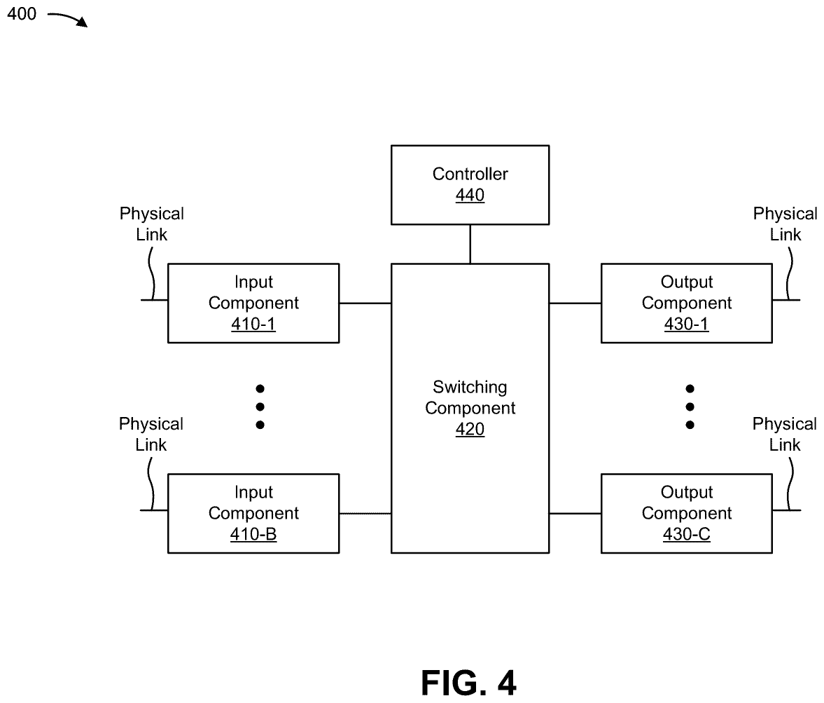

FIG. 4 is a diagram of example components of one or more devices of FIG. 2. The example components may be included in a device 400. The device 400 may correspond to the network device 220. In some implementations, the network device 220 may include one or more devices 400 and/or one or more components of the device 400. As shown in FIG. 4, the device 400 may include one or more input components 410-1 through 410-B (B≥1) (hereinafter referred to collectively as input components 410, and individually as input component 410), a switching component 420, one or more output components 430-1 through 430-C (C≥1) (hereinafter referred to collectively as output components 430, and individually as output component 430), and a controller 440.

The input component 410 may be one or more points of attachment for physical links and may be one or more points of entry for incoming traffic, such as packets. The input component 410 may process incoming traffic, such as by performing data link layer encapsulation or decapsulation. In some implementations, the input component 410 may transmit and/or receive packets. In some implementations, the input component 410 may include an input line card that includes one or more packet processing components (e.g., in the form of integrated circuits), such as one or more interface cards (IFCs), packet forwarding components, line card controller components, input ports, processors, memories, and/or input queues. In some implementations, the device 400 may include one or more input components 410.

The switching component 420 may interconnect the input components 410 with the output components 430. In some implementations, the switching component 420 may be implemented via one or more crossbars, via busses, and/or with shared memories. The shared memories may act as temporary buffers to store packets from the input components 410 before the packets are eventually scheduled for delivery to the output components 430. In some implementations, the switching component 420 may enable the input components 410, the output components 430, and/or the controller 440 to communicate with one another.

The output component 430 may store packets and may schedule packets for transmission on output physical links. The output component 430 may support data link layer encapsulation or decapsulation, and/or a variety of higher-level protocols. In some implementations, the output component 430 may transmit packets and/or receive packets. In some implementations, the output component 430 may include an output line card that includes one or more packet processing components (e.g., in the form of integrated circuits), such as one or more IFCs, packet forwarding components, line card controller components, output ports, processors, memories, and/or output queues. In some implementations, the device 400 may include one or more output components 430. In some implementations, the input component 410 and the output component 430 may be implemented by the same set of components (e.g., and input/output component may be a combination of the input component 410 and the output component 430).

The controller 440 includes a processor in the form of, for example, a CPU, a GPU, an APU, a microprocessor, a microcontroller, a DSP, an FPGA, an ASIC, and/or another type of processor. The processor is implemented in hardware, firmware, or a combination of hardware and software. In some implementations, the controller 440 may include one or more processors that can be programmed to perform a function.

In some implementations, the controller 440 may include a RAM, a ROM, and/or another type of dynamic or static storage device (e.g., a flash memory, a magnetic memory, an optical memory, etc.) that stores information and/or instructions for use by the controller 440.

In some implementations, the controller 440 may communicate with other devices, networks, and/or systems connected to the device 400 to exchange information regarding network topology. The controller 440 may create routing tables based on the network topology information, may create forwarding tables based on the routing tables, and may forward the forwarding tables to the input components 410 and/or output components 430. The input components 410 and/or the output components 430 may use the forwarding tables to perform route lookups for incoming and/or outgoing packets.

The controller 440 may perform one or more processes described herein. The controller 440 may perform these processes in response to executing software instructions stored by a non-transitory computer-readable medium. A computer-readable medium is defined herein as a non-transitory memory device. A memory device includes memory space within a single physical storage device or memory space spread across multiple physical storage devices.

Software instructions may be read into a memory and/or storage component associated with the controller 440 from another computer-readable medium or from another device via a communication interface. When executed, software instructions stored in a memory and/or storage component associated with the controller 440 may cause the controller 440 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 4 are provided as an example. In practice, the device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

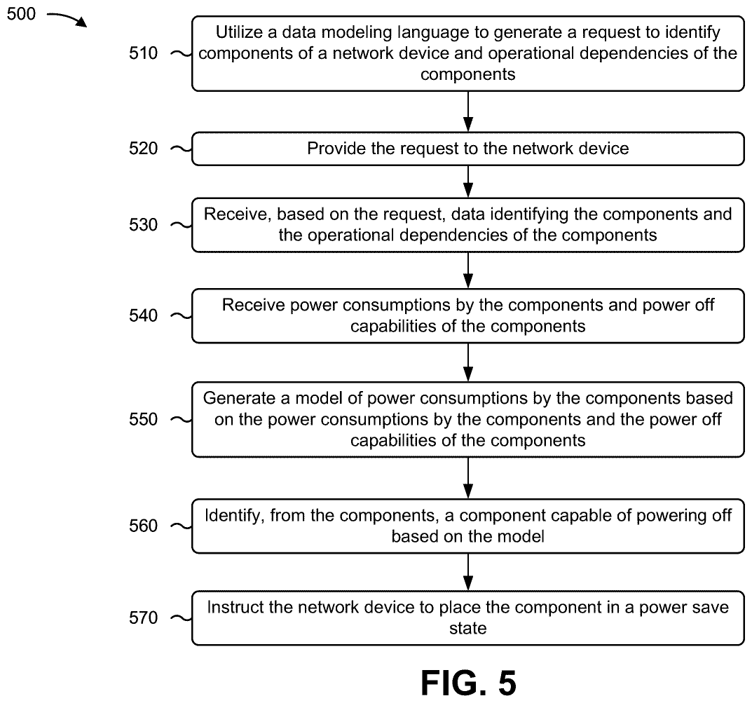

FIG. 5 is a flowchart of an example process 500 for utilizing data modeling for power management of network device components. In some implementations, one or more process blocks of FIG. 5 may be performed by a device (e.g., the management system 230). In some implementations, one or more process blocks of FIG. 5 may be performed by another device or a group of devices separate from or including the device, such as an endpoint device (e.g., the endpoint device 210) and/or a network device (e.g., the network device 220). Additionally, or alternatively, one or more process blocks of FIG. 5 may be performed by one or more components of the device 300, such as the processor 320, the memory 330, the input component 340, the output component 350, and/or the communication interface 360. Additionally, or alternatively, one or more process blocks of FIG. 5 may be performed by one or more components of the device 400, such as the input component 410, the switching component 420, the output component 430, and/or the controller 440.

As shown in FIG. 5, process 500 may include utilizing a data modeling language to generate a request to identify components of a network device and operational dependencies of the components (block 510). For example, the device may utilize a data modeling language to generate a request to identify components of a network device and operational dependencies of the components, as described above. In some implementations, the data modeling language is a yet another next generation data modeling language. In some implementations, the operational dependencies of the components include information indicating components that require other components and components that are used by other components. In some implementations, each of the components of the network device include one or more of a hardware component of the network device, a software component of the network device, or a combined hardware and software component of the network device.

As further shown in FIG. 5, process 500 may include providing the request to the network device (block 520). For example, the device may provide the request to the network device, as described above.

As further shown in FIG. 5, process 500 may include receiving, based on the request, data identifying the components and the operational dependencies of the components (block 530). For example, the device may receive, based on the request, data identifying the components and the operational dependencies of the components, as described above.

As further shown in FIG. 5, process 500 may include receiving power consumptions by the components and power off capabilities of the components (block 540). For example, the device may receive power consumptions by the components and power off capabilities of the components, as described above. In some implementations, the power consumptions by the components are periodically reported by the components. In some implementations, each of the power consumptions by each of the components do not include power consumptions by components dependent on each of the components. In some implementations, the power off capabilities of the components indicate that the components are capable of being powered off or are incapable of being powered off.

As further shown in FIG. 5, process 500 may include generating a model of power consumptions by the components based on the power consumptions by the components and the power off capabilities of the components (block 550). For example, the device may generate a model of power consumptions by the components based on the power consumptions by the components and the power off capabilities of the components, as described above.

As further shown in FIG. 5, process 500 may include identifying, from the components, a component capable of powering off based on the model (block 560). For example, the device may identify, from the components, a component capable of powering off based on the model, as described above.

As further shown in FIG. 5, process 500 may include instructing the network device to place the component in a power save state (block 570). For example, the device may instruct the network device to place the component in a power save state, as described above. In some implementations, the power save state causes the network device to power off the component. In some implementations, the power save state causes the network device to maintain the component on standby. In some implementations, the component is associated with one or more components in the power save state.

In some implementations, process 500 includes receiving a traffic load associated with the network device, and instructing the network device to remove the power save state for the component based on the traffic load. In some implementations, instructing the network device to remove the power save state for the component causes the network device to remove the power save state for the component. In some implementations, process 500 includes identifying, from the components, a plurality of components capable of powering off based on the model, and instructing the network device to place the plurality of components in the power save state.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description but is not intended to be exhaustive or to limit the implementations to the precise form disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
utilizing, by a device, a data modeling language to generate a request to identify components of a network device and operational dependencies of the components;
providing, by the device, the request to the network device;
receiving, by the device and based on the request, data identifying the components and the operational dependencies of the components;
receiving, by the device, power consumptions by the components and power off capabilities of the components;
generating, by the device, a model of power consumptions by the components based on the power consumptions by the components and the power off capabilities of the components;
identifying, by the device and from the components, a component capable of powering off based on the model; and
instructing, by the device, the network device to place the component in a power save state.

2. The method of claim 1, wherein the power save state causes the network device to power off the component.

3. The method of claim 1, wherein the power save state causes the network device to maintain the component on standby.

4. The method of claim 1, further comprising:
receiving a traffic load associated with the network device; and
instructing the network device to remove the power save state for the component based on the traffic load.

5. The method of claim 4, wherein instructing the network device to remove the power save state for the component causes the network device to remove the power save state for the component.

6. The method of claim 1, wherein the data modeling language is a yet another next generation data modeling language.

7. The method of claim 1, wherein the operational dependencies of the components include information indicating components that require other components and components that are used by other components.

8. A device, comprising:
one or more memories; and
one or more processors configured to:
utilize a data modeling language to generate a request to identify components of a network device and operational dependencies of the components;
provide the request to the network device;
receive, based on the request, data identifying the components and the operational dependencies of the components;
receive power consumptions by the components and power off capabilities of the components;
generate a model of power consumptions by the components based on the power consumptions by the components and the power off capabilities of the components;
identify, from the components, a component capable of powering off based on the model;
instruct the network device to place the component in a power save state;
receive, a traffic load associated with the network device; and
instruct the network device to remove the power save state for the component based on the traffic load.

9. The device of claim 8, wherein the power consumptions by the components are periodically reported by the components.

10. The device of claim 8, wherein each of the power consumptions by each of the components do not include power consumptions by components dependent on each of the components.

11. The device of claim 8, wherein the power off capabilities of the components indicate that the components are capable of being powered off or are incapable of being powered off.

12. The device of claim 8, wherein the one or more processors are further to:
identify, from the components, a plurality of components capable of powering off based on the model; and
instruct the network device to place the plurality of components in the power save state.

13. The device of claim 8, wherein each of the components of the network device include one or more of a hardware component of the network device, a software component of the network device, or a combined hardware and software component of the network device.

14. The device of claim 8, wherein the component is associated with one or more components in the power save state.

15. A non-transitory computer-readable medium storing a set of instructions, the set of instructions comprising:
one or more instructions that, when executed by one or more processors of a device, cause the device to:
utilize a data modeling language to generate a request to identify components of a network device and operational dependencies of the components;
provide the request to the network device;
receive, based on the request, data identifying the components and the operational dependencies of the components;
receive power consumptions by the components and power off capabilities of the components,
wherein the power off capabilities of the components indicate that the components are capable of being powered off or are incapable of being powered off;
generate a model of power consumptions by the components based on the power consumptions by the components and the power off capabilities of the components;
identify, from the components, a component capable of powering off based on the model; and
instruct the network device to place the component in a power save state.

16. The non-transitory computer-readable medium of claim 15, wherein the one or more instructions further cause the device to:
receive, a traffic load associated with the network device; and
instruct the network device to remove the power save state for the component based on the traffic load.

17. The non-transitory computer-readable medium of claim 15, wherein the data modeling language is a yet another next generation data modeling language.

18. The non-transitory computer-readable medium of claim 15, wherein the operational dependencies of the components include information indicating components that require other components and components that are used by other components.

19. The non-transitory computer-readable medium of claim 15, wherein each of the power consumptions by each of the components do not include power consumptions by components dependent on each of the components.

20. The non-transitory computer-readable medium of claim 15, wherein the one or more instructions further cause the device to:
identify, from the components, a plurality of components capable of powering off based on the model; and
instruct the network device to place the plurality of components in the power save state.
